(19) United States
(12) Patent Application Publication
(10) Pub. No.: US 2022/0204375 A1
(43) Pub. Date: Jun. 30, 2022

(54) SYSTEM AND METHOD OF TREATING WASTE WATER

(71) Applicant: Industrial Technology Research Institute, Hsinchu (TW)

(72) Inventors: Chia-Hua Ho, Miaoli County (TW); David Chiuni Wang, Hsinchu City (TW); Tsui-Jung Yang, Hsinchu County (TW); Sin-Yi Huang, Miaoli County (TW); Yi-Fong Pan, Kaohsiung City (TW); Po-I Liu, Kaohsiung City (TW); Guan-You Lin, Hsinchu County (TW); Ren-Yang Horng, Hsinchu County (TW); Teh-Ming Liang, Tainan City (TW)

(73) Assignee: Industrial Technology Research Institute, Hsinchu (TW)

(21) Appl. No.: 17/137,420

(22) Filed: Dec. 30, 2020

(51) Int. Cl. C02F 9/00; B01D 61/00; B01D 61/44; B01D 61/48; B01D 61/02

(52) U.S. Cl. CPC C02F 9/00; B01D 61/005; C02F 1/445; B01D 61/48; B01D 61/025; B01D 61/445

(57) ABSTRACT

Provided are a system and a method of treating wastewater. The system includes a forward osmosis (FO) liquid concentration apparatus and an electrodialysis (ED) apparatus. The FO liquid concentration apparatus increases the concentration of the salt in the wastewater to between 7% and 14%. The ED apparatus is disposed downstream of the FO liquid concentration apparatus and coupled to the FO liquid concentration apparatus to receive the wastewater introduced by the FO liquid concentration apparatus, and make the salt in the wastewater into an acid solution and a basic solution.

### BACKGROUND

### Technical Field

The present disclosure relates to a system and a method of treating wastewater.

### Description of Related Art

In recent years, circular economy and low environmental impact technologies have received much attention, and thus the demand for zero liquid discharge (ZLD) and water resource recovery technologies has been increased. In the current ZLD technology, the wastewater is subjected to a pre-treatment and a reverse osmosis (RO) treatment, and then the salts in the wastewater are separated, evaporated, crystallized and dried. However, the treatment cost of the above-mentioned wastewater treating technology is expensive, and the salts finally produced can only be discarded and buried, thus causing pollution to the environment and ecology.

### SUMMARY

The present disclosure provides a system of treating wastewater, which includes a forward osmosis (FO) liquid concentrating apparatus and an electrodialysis (ED) apparatus.

The present disclosure provides a method of treating wastewater, in which a forward osmosis liquid concentrating apparatus is used to increase the concentration of the salts in the wastewater to between 7% and 14%, and an electrodialysis apparatus is used to convert the salts in the wastewater into an acid solution and a basic solution.

A system of treating wastewater of the present disclosure includes a forward osmosis (FO) liquid concentration apparatus and an electrodialysis (ED) apparatus. The FO liquid concentration apparatus increases the concentration of the salt in the wastewater to between 7% and 14%. The ED apparatus is disposed downstream of the FO liquid concentration apparatus and coupled to the FO liquid concentration apparatus to receive the wastewater introduced by the FO liquid concentration apparatus, and make the salt in the wastewater into an acid solution and a basic solution.

A method of treating wastewater of the present disclosure includes the following steps. A wastewater is provided to a forward osmosis liquid concentrating apparatus to increase the concentration of a salt in the wastewater to between 7% and 14%. The wastewater is introduced into the electrodialysis apparatus through the forward osmosis liquid concentrating apparatus to make the salt in the wastewater into an acid solution and a basic solution.

To make the aforementioned more comprehensible, several embodiments accompanied with drawings are described in detail as follows.

### BRIEF DESCRIPTION OF THE DRAWINGS

FIG. 1 is a block diagram of a system for treating the wastewater of an embodiment of the present disclosure.

FIG. 2 is a flowchart of a method for treating wastewater of an embodiment of the present disclosure.

FIG. 3 is a schematic diagram of an electrodialysis apparatus of an embodiment of the present disclosure.

### DESCRIPTION OF THE EMBODIMENTS

The embodiments are described in detail below with reference to the accompanying drawings, but the embodiments are not intended to limit the scope of the present disclosure.

The terms mentioned in the text, such as “comprising”, “including” and “having” are all open-ended terms, i.e., meaning “including but not limited to”.

In addition, in the text, the range represented by “a value to another value” is a summary expression way to avoid listing all the values in the range one by one in the specification. Therefore, the record of a specific numerical range covers any numerical value within the numerical range, as well as a smaller numerical range defined by any numerical value within the numerical range.

In the embodiment of the present disclosure, a wastewater treating system includes a forward osmosis liquid concentrating apparatus and an electrodialysis apparatus. Through the forward osmosis liquid concentrating apparatus, the concentration of the salts in the wastewater may be concentrated to between 7% and 14%. In this way, when the salts in the wastewater are converted into an acid solution and a basic solution by the electrodialysis apparatus, the efficiency may be improved. In addition, after the salts in the wastewater are converted into the acid solution and the basic solution, the remaining aqueous solution may be mixed with the untreated wastewater, and then the mixture may be provided to the forward osmosis liquid concentrating apparatus and the electrodialysis apparatus. Next, the above steps are repeated to achieve the zero wastewater discharge. The system and the wastewater treating method of the embodiment of the present disclosure will be described in detail below.

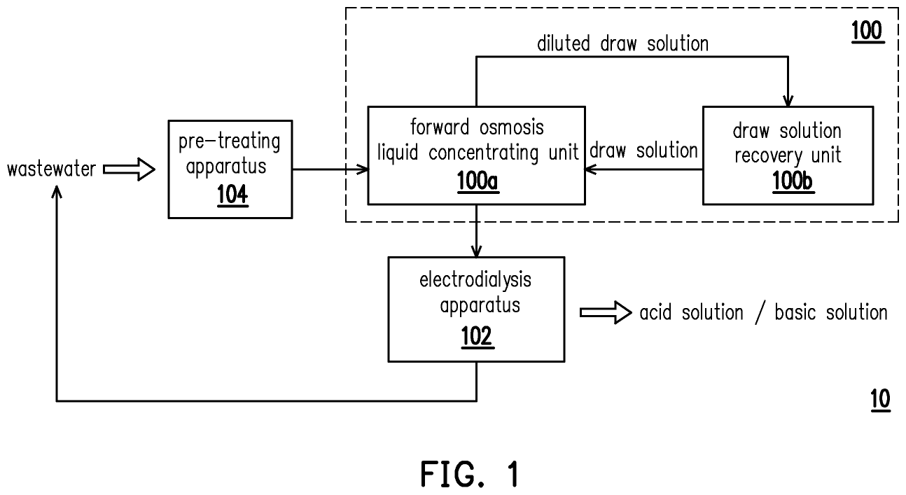

FIG. 1 is a block diagram of a system of treating the wastewater of an embodiment of the present disclosure. Referring to FIG. 1, the wastewater treating system 10 of the present disclosure embodiment includes a forward osmosis liquid concentrating apparatus 100 and an electrodialysis apparatus 102. In addition, depending on actual needs, the wastewater treating system 10 may further include a pre-treating apparatus 104. The wastewater treating system 10 is used to treat the wastewater containing salts. The salts may include sodium chloride, sodium sulfate, lithium chloride, lithium sulfate or a combination thereof. In the case that the wastewater treating system 10 includes the pre-treating apparatus 104, the wastewater may be first provided to the pre-treating apparatus 104 for the pre-treatment, the forward osmosis liquid concentrating apparatus 100 is disposed downstream of the pre-treating apparatus 104 and coupled to the pre-treating apparatus 104, and the electrodialysis apparatus 102 is disposed downstream of the forward osmosis liquid concentrating apparatus 100 and coupled to the forward osmosis liquid concentrating apparatus 100.

The above pre-treating apparatus 104 may pre-treat the wastewater containing the salts to concentrate the concentration of the salts in the wastewater to 4% or more, but less than 7%. The pre-treating apparatus 104 is, for example, a well-known reverse osmosis apparatus, which may concentrate the concentration of the salts in the wastewater up to about 4%. The increase of the concentration of the salts in the wastewater may facilitate the efficiency of making the salts into an acid solution and a basic solution in the subsequent process. In addition, in an embodiment, the pre-treating apparatus 104 may include a former treating apparatus and a reverse osmosis apparatus. The former treating apparatus may first concentrate the concentration of the salts in the wastewater to about 1%, and then the reverse osmosis apparatus may increase the concentration of the salts to about 2% to 4%.

The above forward osmosis liquid concentrating apparatus 100 is disposed downstream of the pre-treating apparatus 104 and coupled with the pre-treating apparatus 104 to receive wastewater from the pre-treating apparatus 104. After the wastewater whose concentration of salts is initially increased enters the forward osmosis liquid concentrating apparatus 100, the forward osmosis liquid concentrating apparatus 100 concentrates the salts in the wastewater again. In this embodiment, forward osmosis liquid concentrating apparatus 100 increases the concentration of salts in wastewater to between 7% and 14%. In this way, the efficiency of subsequently making the salt into acid and a basic solution can be greatly improved.

In the present embodiment, the forward osmosis liquid concentrating apparatus 100 includes a forward osmosis liquid concentrating unit 100a and a draw solution recovery unit 100b. The forward osmosis liquid concentrating unit 100a is coupled to the pre-treating apparatus 104, and the draw solution recovery unit 100b is coupled to the forward osmosis liquid concentrating unit 100a. The forward osmosis liquid concentrating unit 100a is equipped with a membrane. By the osmotic pressure difference between two ends of the membrane as the driving force, the water at the inlet end (low concentration of the salts and low osmotic pressure) is drawn to the draw solution end (high concentration of the salts and high osmotic pressure). At this time, the concentration of the salts in the wastewater increases, while the concentration of the draw solution at the draw solution end decreases by the dilution with water. In addition, the diluted draw solution is discharged to the draw solution recovery unit 100b, and the draw solution recovery unit 100b concentrates the diluted draw solution and then supplies it to the draw solution end of the forward osmosis liquid concentrating unit 100a, so that the forward osmosis liquid concentrating unit 100a may continuously concentrate the salts in the wastewater. However, the forward osmosis liquid concentrating apparatus used in the present disclosure, and but it is also not limited thereto.

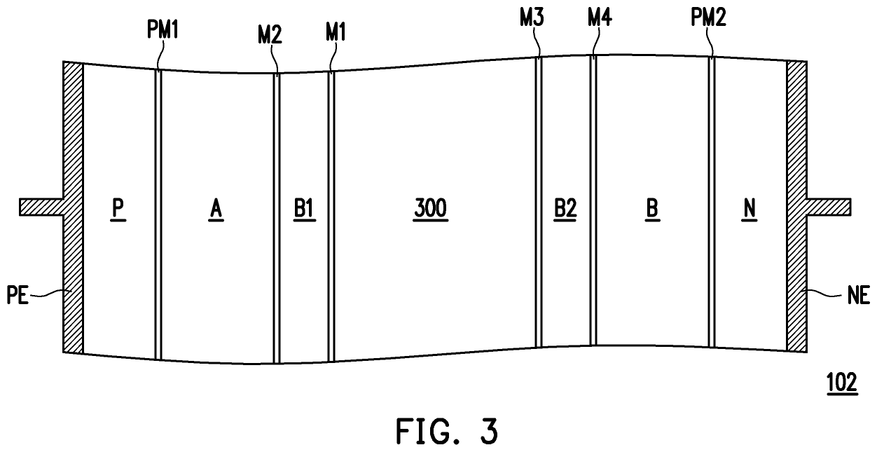

The above electrodialysis apparatus 102 is disposed downstream of the forward osmosis liquid concentrating apparatus 100 and coupled to the forward osmosis liquid concentrating apparatus 100. In an embodiment, the electrodialysis apparatus 102 may be as shown in FIG. 3. Referring to FIG. 3, the electrodialysis apparatus 102 of the embodiment of the present disclosure includes a wastewater chamber 300, a positive electrode chamber P, a negative electrode chamber N, an acid solution chamber A, a basic solution chamber B, a first buffer chamber B1 and a second buffer chamber B2. The wastewater chamber 300 is used to receive the wastewater containing the salts. The positive electrode chamber P and the negative electrode chamber N are respectively disposed on opposite sides of the wastewater chamber 300. The positive electrode chamber P is equipped with an electrode PE and is used to receive the electrode chamber solution (such as sodium sulfate solution). The negative electrode chamber N is equipped with an electrode NE and is used to receive the electrode chamber solution (such as sodium sulfate solution). When the voltages are applied to electrode PE and electrode NE, the anion of the salts in the wastewater may move toward the positive electrode, and the cation of the salts in the wastewater may move toward the negative electrode. In this way, the concentration of the salts in the wastewater may be reduced to achieve the purpose of the wastewater treatment. In an embodiment, during the wastewater treatment, the current density is, for example, between 10 mA/cm² and 100 mA/cm². In this way, the concentration of the salts in the wastewater may be reduced to achieve the purpose of the wastewater treatment.

The acid solution chamber A is disposed between the wastewater chamber 300 and the positive electrode chamber P, and is connected to the positive electrode chamber P. The acid solution chamber A is used to receive the aqueous solution (such as pure water) and the anion from the first buffer chamber B1, which will be described later. In the present embodiment, the interface between the acid solution chamber A and the positive electrode chamber P is a bipolar membrane PM1. The hydroxide ions (OH⁻) in the bipolar membrane PM1 move toward the positive electrode and to the positive electrode chamber P, and the hydrogen ions (H⁺) in the bipolar membrane PM1 and the anion from the first buffer chamber B1 form the acid solution in the acid solution chamber A. The acid solution concentration in the acid solution chamber A increases with the increase of the wastewater treatment time until the required acid solution concentration (hereinafter the target concentration of anion in the acid solution) is reached. At this time, the acid solution produced may be received from the acid solution chamber A to achieve the purpose of reuse of wastewater.

The basic solution chamber B is disposed between the wastewater chamber 300 and the negative electrode chamber N, and is connected to the negative electrode chamber N. The basic solution chamber B is used to receive the aqueous solution (such as pure water) and the cation from the second buffer chamber B2, which will be described later. In the present embodiment, the interface between the basic solution chamber B and the negative electrode chamber N is a bipolar membrane PM2. The hydroxide ions (OH⁻) in the bipolar membrane PM2 move toward the negative electrode and to the negative electrode chamber N, and the hydrogen ions (H⁺) in the bipolar membrane PM2 and the cation from the second buffer chamber B2 form the basic solution in the basic solution chamber B. The basic solution concentration in the basic solution chamber B increases with the increase of the wastewater treatment time until the required basic solution concentration (hereinafter the target concentration of cation in the basic solution) is reached. At this time, the basic solution produced may be received from the basic solution chamber B to achieve the purpose of reuse of wastewater.

The first buffer chamber B1 is disposed between the acid solution chamber A and the wastewater chamber 300, and is connected to the acid solution chamber A and the wastewater chamber 300. The first buffer chamber B1 is used to receive a first buffer solution containing the same anion as the anion in the acid solution to be made, i.e., the anion to be recycled and reused in the wastewater. In the present embodiment, the interface between the first buffer chamber B1 and the wastewater chamber 300 is an anion exchange membrane M1, and the interface between the first buffer chamber B1 and the acid solution chamber A is an anion exchange membrane M2. In other words, the interface between the first buffer chamber B1 and the wastewater chamber 300 and the interface between the first buffer chamber B1 and the acid solution chamber A have the same electrical properties. In this way, during the wastewater treatment, the anions of salt in the wastewater move toward the positive electrode and into the first buffer chamber B1, and the anions in the first buffer chamber B1 same as the anions in the acid solution to be made move into the acid solution chamber A to form the acid solution with hydrogen ions from the bipolar membrane PM1.

In addition, in the present embodiment, the concentration of the anion in the first buffer solution is not lower than the target concentration of the same anion in the wastewater chamber 300 and not higher than the target concentration of the same anion in the acid solution chamber A. Since the anion concentration in the first buffer solution is between the target concentration in the wastewater chamber 300 and the target concentration in the acid solution chamber A, when the ion concentration in the wastewater chamber 300 decreases as the wastewater treatment time increases, the phenomenon that the water in the wastewater chamber 100 moves into the acid chamber A due to the excessive osmotic pressure difference between the acid chamber A and the wastewater chamber 300 may be slow down, so as to avoid the reduction of the recovery concentration of the acid solution. In addition, by the first buffer chamber B1, the ions in the acid chamber A may be prevented from returning to the wastewater chamber 300 due to the excessive ion concentration difference, so as to avoid the reduction of the efficiency of the wastewater treatment and the acid solution recovery. In addition, since the anion in the first buffer solution is the same as the anion in the acid solution to be made, even if there are multiple anions in the wastewater, these anions only move into the first buffer chamber B1, while the anion in the first buffer solution may move into the acid solution chamber A, which may improve the purity of the prepared acid solution.

The second buffer chamber B2 is disposed between the basic solution chamber B and the wastewater chamber 300, and is connected to the basic solution chamber B and the wastewater chamber 300. The second buffer chamber B2 is used to receive a second buffer solution containing the same cation as the cation in the basic solution to be made, i.e., the cation to be recycled and reused in the wastewater. In the present embodiment, the interface between the second buffer chamber B2 and the wastewater chamber 300 is a cation exchange membrane M3, and the interface between the second buffer chamber B2 and the basic solution chamber B is a cation exchange membrane M4. In other words, the interface between the second buffer chamber B2 and the wastewater chamber 300 and the interface between the second buffer chamber B2 and the basic solution chamber B have the same electrical properties. In this way, during the wastewater treatment, the cations of salt in the wastewater move toward the negative electrode and into the second buffer chamber B2, and the cations in the second buffer chamber B2 same as the cations in the basic solution to be made move into the basic solution chamber B to form the basic solution with hydroxide ions from the bipolar membrane PM2.

In addition, in the present embodiment, the concentration of the cation in the second buffer solution is not lower than the target concentration of the same cation in the wastewater chamber 300 and not higher than the target concentration of the same cation in the basic solution chamber B. Since the cation concentration in the second buffer solution is between the target concentration in the wastewater chamber 300 and the target concentration in the basic solution chamber B, when the ion concentration in the wastewater chamber 300 decreases as the wastewater treatment time increases, the phenomenon that the water in the wastewater chamber 100 moves into the basic chamber B due to the excessive osmotic pressure difference between the basic chamber B and the wastewater chamber 300 may be slow down, so as to avoid the reduction of the recovery concentration of the basic solution. In addition, by the second buffer chamber B2, the ions in the basic chamber B may be prevented from returning to the wastewater chamber 300 due to the excessive ion concentration difference, so as to avoid the reduction of the efficiency of the wastewater treatment and the basic solution recovery. In addition, since the cation in the second buffer solution is the same as the cation in the basic solution to be made, even if there are multiple cations in the wastewater, these cations only move into the second buffer chamber B2, while the cation in the second buffer solution may move into the basic solution chamber B, which may improve the purity of the prepared basic solution.

In the embodiment of the present disclosure, the first buffer chamber B1 is disposed between the acid solution chamber A and the wastewater chamber 300, and the second buffer chamber B2 is disposed between the basic solution chamber B and the wastewater chamber 300. Therefore, the first buffer chamber B1 and the second buffer chamber B2 may reduce the concentration gap between the wastewater chamber 300 and the acid solution chamber A and the basic solution chamber B, respectively, and a concentration gradient is formed, so that the ions in the acid solution chamber A or in the basic solution chamber B may not move back to the wastewater chamber 300 and the osmotic pressure difference is reduced. In other words, if the first buffer chamber B1 is not disposed between the acid solution chamber A and the wastewater chamber 300 and/or the second buffer chamber B2 is not disposed between the basic solution chamber B and the wastewater chamber 300, the problem that reduced recovery efficiency of the acid solution and/or the basic solution due to a large concentration gap between the wastewater chamber 300 and the acid solution chamber A and/or the basic solution chamber B cannot be solved.

In addition, in the present embodiment, the first buffer chamber B1 and the second buffer chamber B2 are separated chambers, and the first buffer chamber B1 and the second buffer chamber B2 are communicated with each other. Therefore, the first buffer solution is the same as the second buffer solution, and both contain the anion needed to produce the acid solution and the cation needed to produce the basic solution. In another embodiment, the first buffer chamber B1 may be not communicated with the second buffer chamber B2. In this case, the first buffer solution is different from the second buffer solution.

In other embodiments, the electrodialysis apparatus 102 may have a structure similar to that shown in FIG. 3, but the first buffer chamber B1 and the second buffer chamber B2 may be omitted. In other embodiments, the present disclosure may be implemented without the buffer chamber disposed in the electrodialysis apparatus 102.

In the present embodiment, the wastewater chamber 300 of the electrodialysis apparatus 102 is coupled to the forward osmosis liquid concentrating unit 100a, and the wastewater chamber 300 of the electrodialysis apparatus 102 receives the wastewater (the concentration of the salts has been increased to 7% to 14%) introduced from the forward osmosis liquid concentrating apparatus 100, and the salts in the wastewater are converted into an acid solution and a basic solution. Since the electrodialysis apparatus 102 is equipped with a charged dialysis membrane, the ions may be separated in the aqueous solution by using the potential difference as a driving force. Through the above procedures, the electrodialysis apparatus 102 may separate the anion and cation of the salts in the wastewater, and the water may be converted into hydrogen ions and hydroxide ions through the bipolar membrane. As a result, an acid solution (such as sulfuric acid, hydrochloric acid, etc.) and a basic solution (such as sodium hydroxide, lithium hydroxide, etc.) are made, and the made acid solution and basic solution may be used in various industries. In addition, the remaining aqueous solution after the acid solution and basic solution are made may also be used, or may be mixed with untreated wastewater and provided to the pre-treating apparatus 104 or the forward osmosis liquid concentrating apparatus 100 for a continuous wastewater treatment.

It can be seen from the above that through the electrodialysis apparatus 102 of the embodiment of the present disclosure, the wastewater may be treated and the acid solution and the basic solution may be made, and the remaining aqueous solution after the acid solution and the basic solution are made may be used or may be mixed with untreated wastewater and subjected the wastewater treatment. In this way, the environmental and ecological pollution problems caused by the waste and burial of the salts may be effectively solved, and the goal of zero discharge of the wastewater may be achieved at the same time.

In addition, the wastewater treating system 10 of the embodiment of the present disclosure includes the forward osmosis liquid concentrating apparatus 100 and the electrodialysis apparatus 102, and the concentration of the salts is not increased by a thermal evaporation apparatus. As a result, the energy consumption and the cost of the wastewater treatment may be effectively reduced.

The method of the wastewater treatment of the embodiment of the present disclosure will be described below.

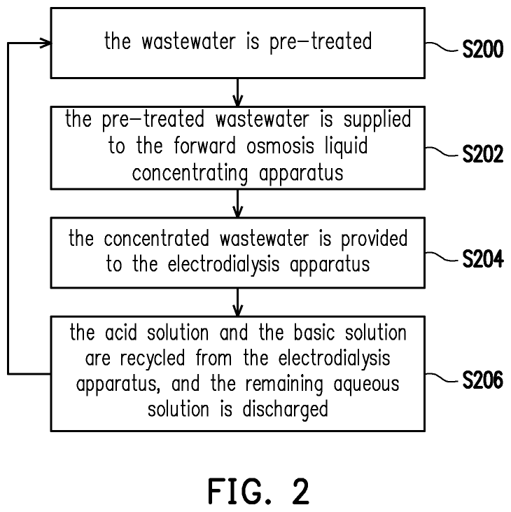

FIG. 2 is a flowchart of a method for treating wastewater of an embodiment of the present disclosure. Referring to FIGS. 1 and 2, in the step S200, the wastewater containing salts (such as sodium chloride, sodium sulfate, lithium chloride, lithium sulfate or a combination thereof) is provided to the pre-treating apparatus 104 to perform the pre-treatment. In this step, the concentration of the salts in wastewater may be concentrated to 4% or more, but less than 7%. In other embodiments, the step S200 may be omitted depending on actual needs.

Next, in the step S202, the pre-treated wastewater is supplied to the forward osmosis liquid concentrating apparatus 100, and the concentration of the salts in the wastewater is concentrated again to increase the concentration of the salts to between 7% and 14%.

Then, in the step S204, the concentrated wastewater is provided to the electrodialysis apparatus 102, which is equipped with an anion exchange membrane, a cation exchange membrane and a bipolar membrane, to convert the wastewater into an acid solution and a basic solution.

After that, in the step S206, the acid solution and the basic solution are recycled from the acid solution chamber and the basic solution chamber of the electrodialysis apparatus. In addition, the remaining aqueous solution in the wastewater chamber of the electrodialysis apparatus may also be recycled, or may be mixed with the untreated wastewater and then the steps S200 to S206 may be repeated. In this way, the wastewater may be made into an acid solution and a basic solution for recovery, and the goal of zero discharge of the wastewater may be achieved at the same time.

Hereinafter, Experimental examples and Comparative examples are used to illustrate the wastewater treating system and the wastewater treating method of the present disclosure, and the treatment results are shown in Table 1.

<forward osmosis liquid concentrating apparatus >: Na₂SO₄ draw solution/flow velocity 25 cm/s/the effective operating area of the permeable membrane: 1 m²

<electrodialysis apparatus >: as shown in FIG. 3

### Experimental Example 1

According to embodiments of the disclosure, the concentration of the Na₂SO₄ draw solution of the forward osmosis liquid concentrating apparatus is 30% and the osmotic pressure is 89 atm, the wastewater containing NaCl is supplied to the forward osmosis liquid concentrating apparatus and concentrated for 4 hours to increase the concentration of NaCl from 3.5% to 7.5%. After that, the concentrated wastewater is provided to the electrodialysis apparatus to make into HCl and NaOH.

### Experimental Example 2

According to embodiments of the disclosure, the concentration of the Na₂SO₄ draw solution of the forward osmosis liquid concentrating apparatus is 30% and the osmotic pressure is 89 atm, the wastewater containing NaCl is supplied to the forward osmosis liquid concentrating apparatus and concentrated for 4.5 hours to increase the concentration of NaCl from 3.5% to 8%. After that, the concentrated wastewater is provided to the electrodialysis apparatus to make into HCl and NaOH.

### Experimental Example 3

According to embodiments of the disclosure, the concentration of the Na₂SO₄ draw solution of the forward osmosis liquid concentrating apparatus is 40% and the osmotic pressure is 117 atm, the wastewater containing NaCl is supplied to the forward osmosis liquid concentrating apparatus and concentrated for 4 hours to increase the concentration of NaCl to 12.6%. After that, the concentrated wastewater is provided to the electrodialysis apparatus to make into HCl and NaOH.

### Comparative Example

The wastewater containing 4% NaCl is directly provided to the electrodialysis apparatus, and the concentration of NaCl is not increased to between 7% and 14% by the forward osmosis liquid concentrating apparatus. Then, the wastewater is made into HCl and NaOH.

TABLE 1

| | Comparative | | Experimental | | Experimental | | Experimental | |
|---|---|---|---|---|---|---|---|---|
| | example | | example 1 | | example 2 | | example 3 | |
| produced acid solution/ | HCl | NaOH | HCl | NaOH | HCl | NaOH | HCl | NaOH |
| basic solution after | | | | | | | | |
| electrodialysis | | | | | | | | |
| concentration of HCl/ | 2.1 | 2.6 | 4.6 | 4.5 | 5.3 | 5.2 | 8.3 | 7.1 |
| NaOH (%) | | | | | | | | |
| energy consumption | 9 | 7 | 9 | 8 | 9 | 9 | 10 | 9 |
| (kWh/kg) | | | | | | | | |
| current efficiency (%) | 57 | 25 | 74 | 48 | 77 | 51 | 88 | 79 |

It can be clearly seen from Table 1 that compared to the Comparative example (the concentration of the salts in wastewater is not increased to between 7% and 14% through the forward osmosis liquid concentrating apparatus), in the wastewater treating system of the embodiment of the present disclosure, the concentration of the salts in the wastewater is increased to between 7% and 14% through the forward osmosis liquid concentrating apparatus, which may effectively increase the concentration of the acid solution and the basic solution produced, and may effectively increase the acid/base recovery rate and the current efficiency.

It will be apparent to those skilled in the art that various modifications and variations may be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A system of treating wastewater, comprising:
a forward osmosis liquid concentrating apparatus, increasing the concentration of a salt in a wastewater to between 7% and 14%; and
an electrodialysis apparatus, disposed downstream of the forward osmosis liquid concentrating apparatus and coupled to the forward osmosis liquid concentrating apparatus, receiving the wastewater introduced by the forward osmosis liquid concentrating apparatus, and making the salt in the wastewater into an acid solution and a basic solution.

2. The system of treating wastewater of claim 1, further comprising a pre-treating apparatus, disposed upstream of the forward osmosis liquid concentrating apparatus and coupled to the forward osmosis liquid concentrating apparatus to increase the concentration of the salt in the wastewater to 4% or more, but less than 7%.

3. The system of treating wastewater of claim 1, wherein the forward osmosis liquid concentrating apparatus comprises a forward osmosis liquid concentrating unit and an draw solution recovery unit coupled to the forward osmosis liquid concentrating unit, and wherein the draw solution recovery unit receives a diluted draw solution from the forward osmosis liquid concentrating unit and provides an draw solution with an osmotic pressure between 70 atm and 200 atm to the forward osmosis liquid concentrating unit.

4. The system of treating wastewater of claim 1, wherein a dialysis membrane in the electrodialysis apparatus comprises a bipolar membrane, an anion exchange membrane and a cation exchange membrane.

5. The system of treating wastewater of claim 4, wherein the electrodialysis apparatus comprises:
a wastewater chamber, receiving wastewater containing a first ion;
a positive electrode chamber and a negative electrode chamber, respectively disposed on opposite sides of the wastewater chamber;
an acid solution chamber, disposed between the wastewater chamber and the positive electrode chamber;
a basic solution chamber, disposed between the wastewater chamber and the negative electrode chamber; and
a first buffer chamber, disposed between the wastewater chamber and one of the acid solution chamber and the basic solution chamber, and receiving a first buffer solution containing the first ion,
wherein an interface between the wastewater chamber and the first buffer chamber is a first ion exchange membrane, an interface between the first buffer chamber and the one of the acid solution chamber and the basic solution chamber is a second ion exchange membrane, and the first ion exchange membrane and the second ion exchange membrane have the same electrical properties.

6. The system of treating wastewater of claim 1, wherein the salt in the wastewater comprises sodium chloride, sodium sulfate, lithium chloride, lithium sulfate or a combination thereof.

7. A method of treating wastewater, comprising:
providing a wastewater to a forward osmosis liquid concentrating apparatus to increase the concentration of a salt in the wastewater to between 7% and 14%; and
introducing the wastewater into the electrodialysis apparatus through the forward osmosis liquid concentrating apparatus to make the salt in the wastewater into an acid solution and a basic solution.

8. The method of treating wastewater of claim 7, further comprising providing the wastewater to a pre-treating apparatus before providing the wastewater to the forward osmosis liquid concentrating apparatus to increase the concentration of the salt in the wastewater to 4% or more, but less than 7%.

9. The method of treating wastewater of claim 7, further comprising:
providing a draw solution diluted in the forward osmosis liquid concentrating apparatus to a draw solution recovery unit; and
providing a draw solution with an osmotic pressure between 70 atm and 200 atm to the forward osmosis liquid concentrating unit through the draw solution recovery unit.

10. The method of treating wastewater of claim 7, wherein the salt in the wastewater comprises sodium chloride, sodium sulfate, lithium chloride, lithium sulfate or a combination thereof.
